(19) United States
(12) Patent Application Publication
(10) Pub. No.: US 2022/0006237 A1
(43) Pub. Date: Jan. 6, 2022

(54) FLOATING CONNECTOR AND INSULATING BASE THEREOF

(71) Applicant: Greenconn Corp., New Taipei City (TW)

(72) Inventors: TSUNG-LUNG KUO, Taipei City (TW); KUN-SHEN WU, New Taipei City (TW)

(21) Appl. No.: 16/917,911

(22) Filed: Jul. 1, 2020

(51) Int. Cl. H01R 13/631; H01R 13/405; H01R 13/14

(52) U.S. Cl. CPC H01R 13/6315; H01R 12/707; H01R 13/14; H01R 13/405

(57) ABSTRACT

A floating connector and an insulating base thereof are provided. The insulating base includes a ring-shaped frame, a floating carrier spaced apart from the frame, and a plurality of buffer arms that connect the floating carrier to the frame. The frame includes two elongated strips arranged on two opposite sides thereof, and has a buffer opening defined by an inner edge thereof and corresponding in position to the floating carrier. Each of the buffer arms has a first buffer segment connected to the frame and a second buffer segment that curvedly extends from the first buffer segment to the floating carrier. When the floating carrier receives an external force, the first buffer segment and the second buffer segment of any one of the buffer arms absorb the external force respectively along different directions, so that the floating carrier is moved relative to the frame along the different directions.

### FIELD OF THE DISCLOSURE

The present disclosure relates to a connector, and more particularly to a floating connector and an insulating base thereof.

### BACKGROUND OF THE DISCLOSURE

A conventional floating connector includes a housing and a plurality of conductive terminals that are fastened in the housing. The housing is movable relative to the conductive terminals that provide buffering force, thereby achieving a shockproof effect. However, the development of the floating connector is limited by the above structure (e.g., the buffering force of the conventional floating connector being provided only by the conductive terminals).

### SUMMARY OF THE DISCLOSURE

In response to the above-referenced technical inadequacies, the present disclosure provides a floating connector and an insulating base thereof to effectively improve on the issues associated with conventional floating connectors.

In one aspect, the present disclosure provides a floating connector, which includes an insulating base, two terminal modules, and an insulating housing. The insulating base includes a frame, a floating carrier, and a plurality of buffer arms. The frame is in a ring-shape and includes two elongated strips that are arranged on two opposite sides thereof. An inner edge of the frame surroundingly defines a buffer opening. The floating carrier is spaced apart from the frame and corresponds in position to the buffer opening. The buffer aims are connected to and arranged between the floating carrier and the frame. Each of the buffer arms has a first buffer segment connected to the frame and a second buffer segment that curvedly extends from the first buffer segment to the floating carrier. When the floating carrier receives an external force, the first buffer segment and the second buffer segment of any one of the buffer arms absorb the external force respectively along different directions, so that the floating carrier is moved relative to the frame along the different directions. The two terminal modules are fastened to the floating carrier through one side portion thereof and are respectively fastened to the two elongated strips of the frame through another side portion thereof. The insulating housing is sleeved around the floating carrier and having an insertion slot. Each of the two terminal modules is partially arranged in the insertion slot of the insulating housing. The insulating housing is movable relative to the frame along the different directions by the floating carrier and the buffer arms.

In another aspect, the present disclosure provides an insulating base of a floating connector, which includes a frame, a floating carrier, and a plurality of buffer arms. The frame is in a ring-shape and includes two elongated strips that are arranged on two opposite sides thereof. An inner edge of the frame surroundingly defines a buffer opening. The floating carrier is spaced apart from the frame and corresponds in position to the buffer opening. The buffer aims are connected to and arranged between the floating carrier and the frame. Each of the buffer arms has a first buffer segment connected to the frame and a second buffer segment that curvedly extends from the first buffer segment to the floating carrier. When the floating carrier receives an external force, the first buffer segment and the second buffer segment of any one of the buffer arms absorb the external force respectively along different directions, so that the floating carrier is moved relative to the frame along the different directions.

Therefore, the insulating base in the present disclosure is provided with a new structure by forming the buffer arms to connect to the frame and the floating carrier, and each of the buffer arms in the present disclosure has a new structural design, so that the insulating base can provide a buffer function by effectively absorbing the external force along the different directions, achieving a better shockproof effect of the floating connector.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings.

FIG. 1 is a schematic perspective view of a floating connector according to an embodiment of the present disclosure.

FIG. 2 is a schematic perspective view of the floating connector of FIG. 1 from another angle of view.

FIG. 3 is a schematic exploded view of FIG. 1.

FIG. 4 is a schematic exploded view of FIG. 2.

FIG. 5 is a schematic exploded view of FIG. 3 when an insulating housing is omitted.

FIG. 6 is a schematic perspective view showing an insulating base of FIG. 5.

FIG. 7 is a schematic enlarged view showing portion VII of FIG. 6.

FIG. 8 is a schematic top view of FIG. 6.

FIG. 9 is a schematic cross-sectional view taken along line IX-IX of FIG. 1.

FIG. 10 is a schematic cross-sectional view taken along line X-X of FIG. 1.

FIG. 11 is a schematic perspective view of a floating connector according to another embodiment of the present disclosure.

FIG. 12 is a schematic perspective view of a floating connector according to yet another embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

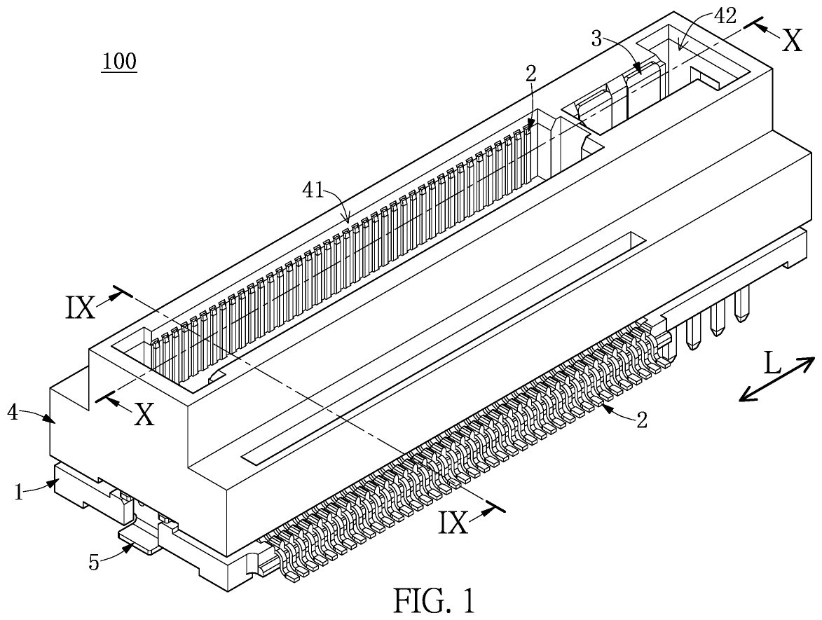

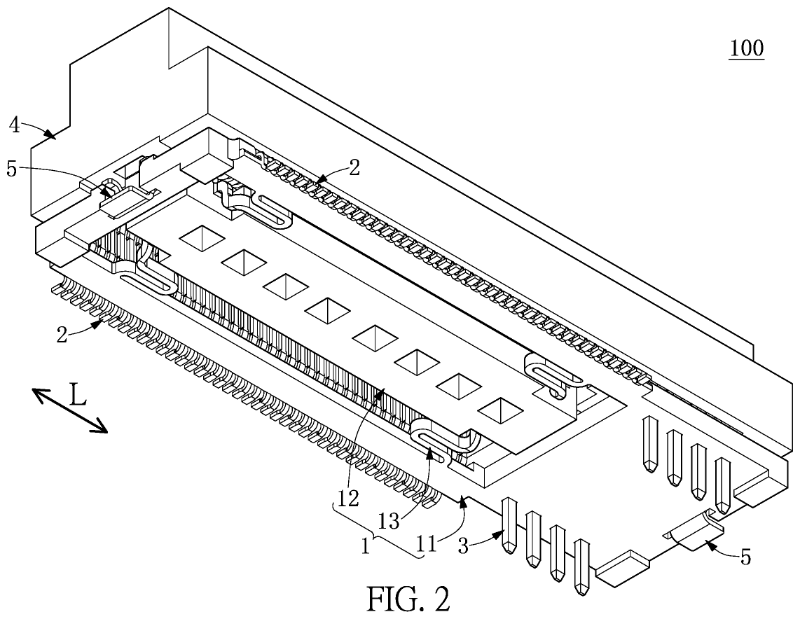

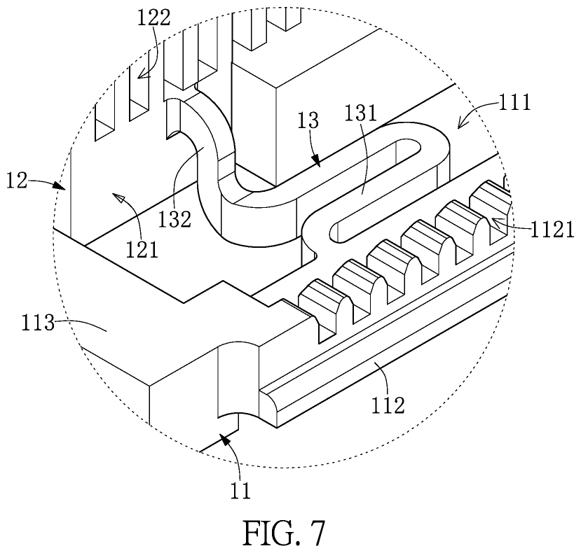

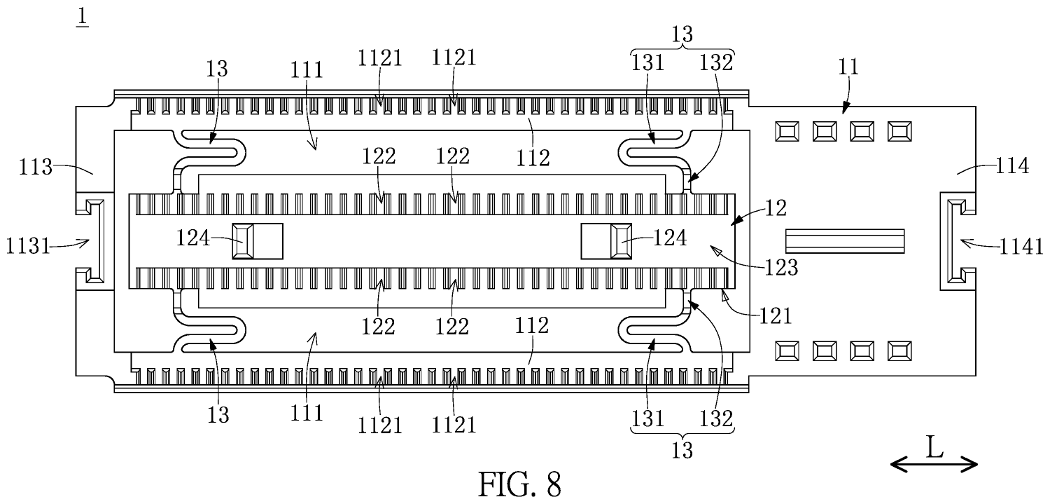

Referring to FIG. 1 to FIG. 12, an embodiment of the present disclosure provides a floating connector 100 for being inserted into a mating connector along an insertion direction and for being applied to a movable object (e.g., a vehicle), but the present disclosure is not limited thereto. In the present embodiment, when any one of the floating connector 100 and the mating connector is moved relative to the other one, an electrical connection between the floating connector 100 and the mating connector can be firmly maintained.

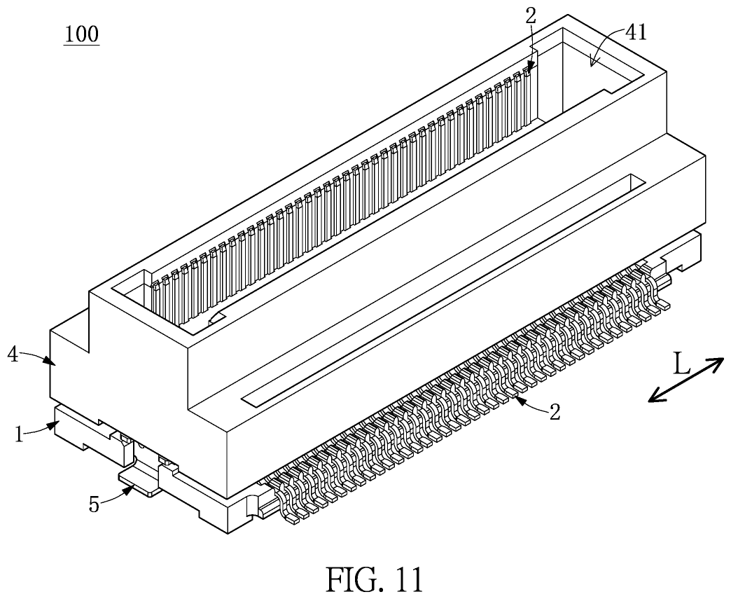

As shown in FIG. 1 to FIG. 4, the floating connector 100 includes an insulating base 1, two terminal modules 2 fastened to the insulating base 1, a plurality of power terminals 3 fastened to the insulating base 1, and an insulating housing 4 that is sleeved around the two terminal modules 2 and the power terminals 3. The floating connector 100 in the present embodiment includes the above components, but the present disclosure is not limited thereto. For example, as shown in FIG. 11, the floating connector 100 can be provided without the power terminals 3 and the corresponding portions of the insulating base 1 and the insulating housing 4 according to design requirements.

Moreover, the insulating base 1 in the present embodiment is used in cooperation with the two terminal modules 2, the power terminals 3, and the insulating housing 4, but the present disclosure is not limited thereto. For example, in other embodiments of the present disclosure, the insulating base 1 can be independently used (e.g., sold) or can be used in cooperation with other components. The following description describes the structure and connection relationship of each component of the floating connector 100.

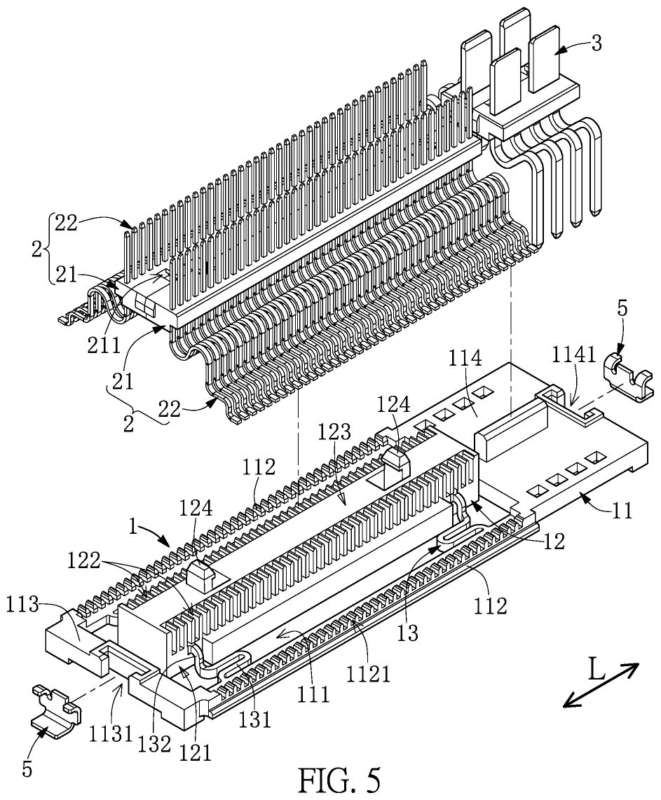

As shown in FIG. 5 to FIG. 8, the insulating base 1 includes a frame 11 being in a ring-shape, a floating carrier 12 spaced apart from the frame 11, and a plurality of buffer aims 13 that are connected to and arranged between the floating carrier 12 and the frame 11. The insulating base 1 in the present embodiment is integrally formed as a one-piece structure, but the present disclosure is not limited thereto. For example, in other embodiments of the present disclosure, the buffer arms 13 can be detachably assembled to (e.g., engaged with) the frame 11 and the floating carrier 12.

An outer contour of the frame 11 is substantially in a rectangular shape, and an inner edge of the frame 11 surroundingly defines a buffer opening 111 that is substantially in a rectangular shape. A longitudinal direction of the buffer opening 111 is parallel to that of the frame 11. The frame 11 includes two elongated strips 112 arranged on two opposite sides thereof, a side strip 113 connected to one end of the two elongated strips 112, and a carrying board 114 that is connected to the other end of the two elongated strips 112. In other words, the two elongated strips 112, the side strip 113, and the carrying board 114 jointly define the buffer opening 111.

Specifically, the two elongated strips 112 in the present embodiment are mirror-symmetrical to the floating carrier 12, but the present disclosure is not limited thereto. For example, in other embodiments of the present disclosure, the two elongated strips 112 can be of different structure. In the present embodiment, each of the two elongated strips 112 is parallel to the longitudinal direction of the frame 11 and has a plurality of positioning slots 1121 arranged in one row.

Moreover, each of the side strip 113 and the carrying board 114 has an installation port 1131, 1141. The installation port 1141 is formed in a portion of the carrying board 114 distant from the buffer opening 111. It should be noted that the two installation ports 1131, 1141 of the frame 11 are configured to respectively and fixedly hold two soldering members 5, so that the insulating base 1 can be soldered onto a circuit board (not shown) through the two soldering members 5, but the present disclosure is not limited thereto.

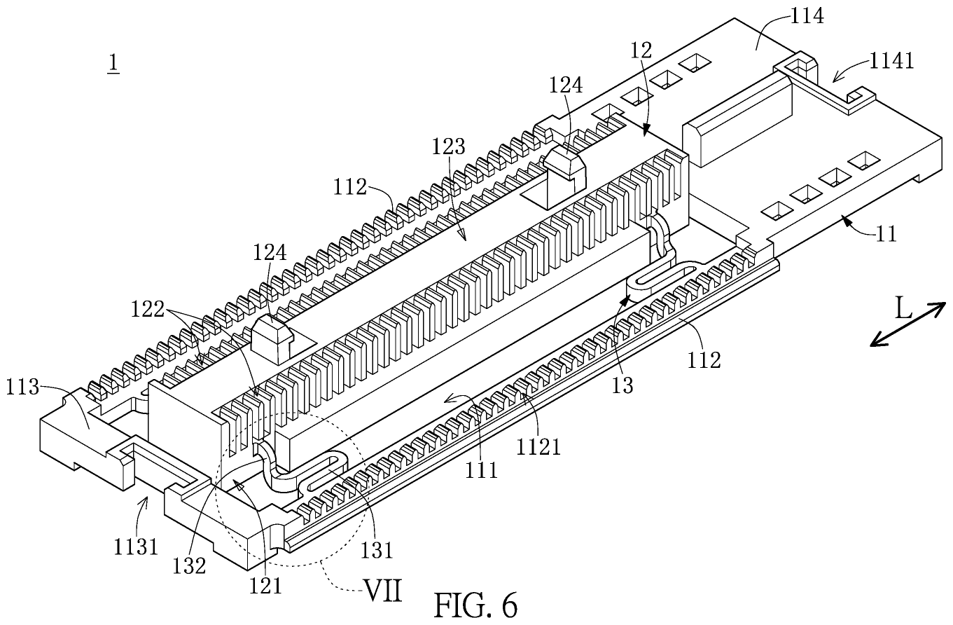

The connection between the floating carrier 12 and the frame 11 in the present embodiment is established only by the buffer arms 13. Moreover, the floating carrier 12 is an elongated structure (e.g., a cuboid) that defines a longitudinal direction L parallel to any one of the two elongated strips 112. The floating carrier 12 corresponds in position to the buffer opening 111, and the floating carrier 12 in the present embodiment is partially (e.g., a bottom portion of the floating carrier 12 shown in FIG. 6) arranged in the buffer opening 111, but the present disclosure is not limited thereto. For example, in other embodiments of the present disclosure, the floating carrier 12 can be arranged above the buffer opening 111, but is not arranged in the buffer opening 111.

Specifically, each long lateral surface 121 of the floating carrier 12 is formed with a plurality of engaging slots 122 that are arranged in one row and that extend to a top surface 123 of the floating carrier 12. In the present embodiment, the engaging slots 122 are arranged outside of (or are arranged above) the buffer opening 111. In the present embodiment, the positions and quantity of the engaging slots 122 recessed in any one of the long lateral surfaces 121 of the floating carrier 12 in the present embodiment respectively correspond to those of the positioning slots 1121 of one of the two elongated strips 112 adjacent thereto.

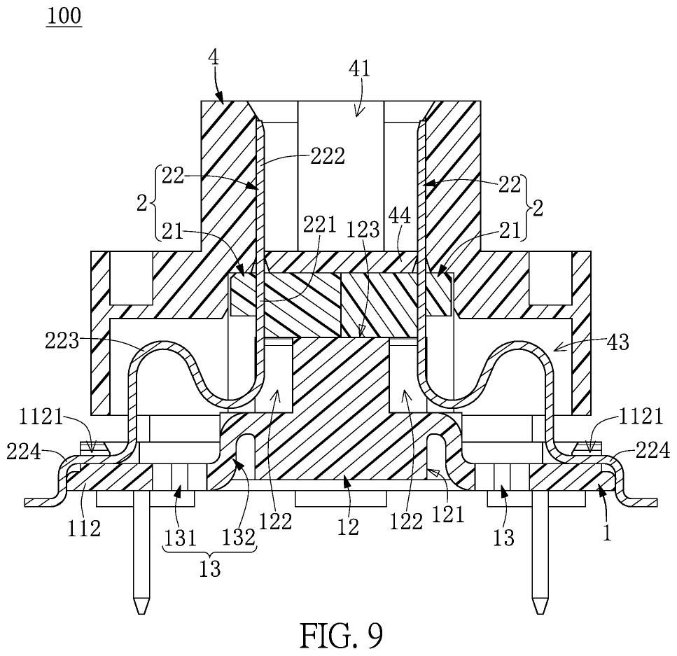

For example, the quantity of the engaging slots 122 recessed in any one of the long lateral surfaces 121 of the floating carrier 12 is equal to that of the positioning slots 1121 of one of the two elongated strips 112 adjacent thereto. Moreover, any one of the engaging slots 122 and the corresponding positioning slot 1121 are arranged at a cross section (e.g., FIG. 9) of the insulating base 1 perpendicular to the longitudinal direction L, and any one of the engaging slots 122 is arranged higher than the corresponding positioning slot 1121.

The quantity of the buffer arms 13 in the present embodiment is four, and the structures of the buffer arms 13 are substantially the same, but the present disclosure is not limited thereto. For example, in other embodiments of the present disclosure, the quantity of the buffer arms 13 can be at least two, or the buffer arms 13 can be of different structure. Each of the buffer arms 13 has a first buffer segment 131 connected to the frame 11 and a second buffer segment 132 that curvedly extends from the first buffer segment 131 to the floating carrier 12.

Specifically, the first buffer segments 131 of the buffer arms 13 are respectively connected to the two elongated strips 112 of the frame 11, and each of the two elongated strips 112 is connected to two of the first buffer segments 131 through two end parts thereof. Each of the first buffer segments 131 is connected to an inner edge of the corresponding elongated strip 112, and the first buffer segments 131 are arranged at an inner side of the positioning slots 1121 of the two elongated strips 112.

Moreover, the second buffer segments 132 of the buffer arms 13 are respectively connected to the two long lateral surfaces 121 of the floating carrier 12, and each of the two long lateral surfaces 121 is connected to two of the second buffer segments 132 through two end parts thereof. Each of the second buffer segments 132 is connected to a lower portion of the corresponding long lateral surface 121 that is lower than the engaging slots 122. However, the lower portion of the long lateral surface 121 connected to any one of the second buffer segments 132 is higher than the positioning slots 1121 of the two elongated strips 112 adjacent thereto.

In other words, a portion of the floating carrier 12 and a portion of the frame 11, which are connected to any one of the buffer arms 13, are located at a cross section (e.g., FIG. 9) of the insulating base 1 perpendicular to the longitudinal direction L and have a height difference there-between.

Accordingly, when the floating carrier 12 receives an external force, the first buffer segment 131 and the second buffer segment 132 of any one of the buffer arms 13 absorb the external force respectively along different directions (e.g., three-dimensional directions shown in FIG. 6), so that the floating carrier 12 is moved relative to the frame 11 along the different directions (e.g., three-dimensional directions shown in FIG. 6).

Moreover, the insulating base 1 in the present embodiment is provided with a new structure by forming the buffer arms 13 to connect the frame 11 and the floating carrier 12, and each of the buffer arms 13 has a new structural design, so that the insulating base 1 can provide a buffer function by effectively absorbing the external force along the different directions, achieving a better shockproof effect of the floating connector 100.

It should be noted that the structure and position of each of the buffer arms 13 is provided for absorbing the external force along the different directions. Accordingly, if the above requirements can be achieved, the structure and position of each of the buffer arms 13 can be adjusted or changed according to design requirements.

In order to clearly describe the present embodiment, the following description only describes the structure and position of each of the buffer arms 13 shown in FIG. 6 to FIG. 8, but the present disclosure is not limited thereto. The buffer arms 13 in the present embodiment are mirror-symmetrical to the floating carrier 12. In each of the buffer arms 13, the first buffer segment 131 is in a U shape and is arranged in the buffer opening 111, and the second buffer segment 132 perpendicularly extends from the first buffer segment 131 to pass through the buffer opening 111 and to connect the floating carrier 12. In other words, two ends of the U-shaped first buffer segment 131 are respectively connected to the inner edge of the corresponding elongated strip 112 and the second buffer segment 132.

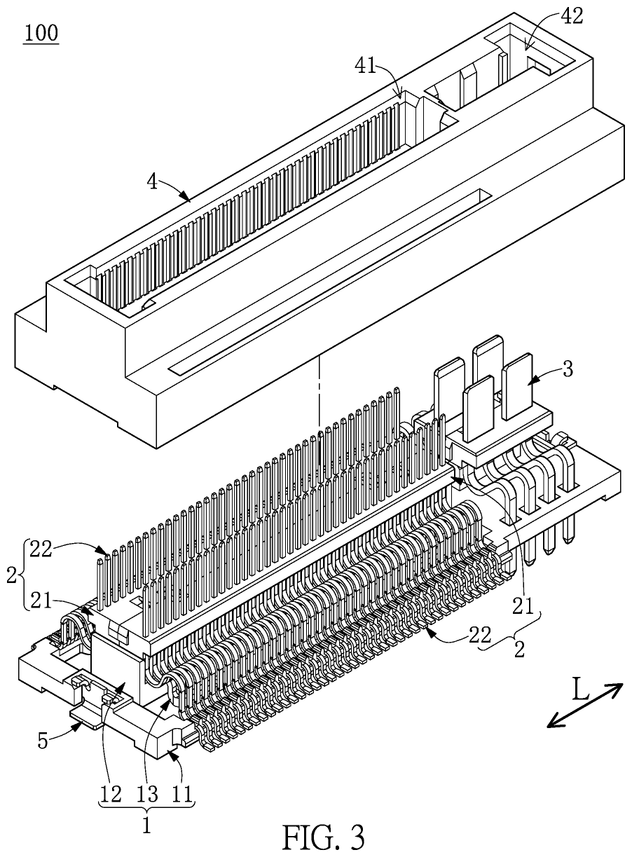

As shown in FIG. 3 to FIG. 5, and FIG. 9, the two terminal modules 2 are fastened to the floating carrier 12 through one side portion thereof and are respectively fastened to the two elongated strips 112 of the frame 11 through another side portion thereof The buffer arms 13 are arranged at an inner side of the two terminal modules 2. Each of the two terminal modules 2 includes a plastic core 21 and a plurality of conductive terminals 22 that are fixed to the plastic core 21 and that are arranged in one row. The two plastic cores 21 are inserted into and fixed with each other.

Specifically, the floating carrier 12 is engaged with the two plastic cores 21, and the engagement between the floating carrier 12 and the two plastic cores 21 can be adjusted or changed according to design requirements. In the present embodiment, the floating carrier 12 has a plurality of hooks 124 extending from the top surface 123 thereof, the two plastic cores 21 are jointly formed with a plurality of fixing holes 211, and the floating carrier 12 are fixed to the two plastic cores 21 by using the hooks 124 to respectively engage with the fixing holes 211, but the present disclosure is not limited thereto. For example, in other embodiments of the present disclosure, the floating carrier 12 can be formed with a plurality of fixing holes, and the two plastic cores 21 are jointly formed with a plurality of hooks that are respectively engaged with the fixing holes.

Moreover, in the present embodiment, the conductive terminals 22 of any one of the two terminal modules 2 respectively face toward and are mirror-symmetrical to the conductive terminals 22 of the other one of the two terminal modules 2. As the conductive terminals 22 are substantially of the same structure, the following description discloses the structure of just one the conductive terminals 22 for the sake of brevity, but the present disclosure is not limited thereto. For example, in other embodiments of the present disclosure, any two of the conductive terminals 22 can be of different structures.

The conductive terminal 22 includes an embedded segment 221, a mating segment 222, and an S-shaped buffer segment 223 respectively extending from two opposite ends of the embedded segment 221, and an end segment 224 extending from the S-shaped buffer segment 223. The embedded segment 221 is fixed and embedded in the corresponding plastic core 21. The mating segment 222 is arranged in an insertion slot 41 of the insulating housing 4 for being in contact with a corresponding terminal of the mating connector. An end of the S-shaped buffer segment 223 (e.g., an end of the S-shaped buffer segment 223 adjacent to the embedded segment 221) is engaged with the floating carrier 12 (e.g., the corresponding engaging slot 122), and the end segment 224 extends from another end of the S-shaped buffer segment 223 and is engaged with the frame 11 (e.g., the corresponding positioning slot 1121) for being soldered onto the circuit board.

Moreover, any one of the power terminals 3 is selectively fastened to the frame 11 (e.g., the carrying board 114) for being in contact with a corresponding power terminal of the mating connector. It should be noted that the quantity of the power terminals 3 can be adjusted or changed according to design requirements, and is not limited to the present embodiment. For example, as shown in FIG. 11, the floating connector 100 can be provided without any power terminal 3 and the corresponding structure.

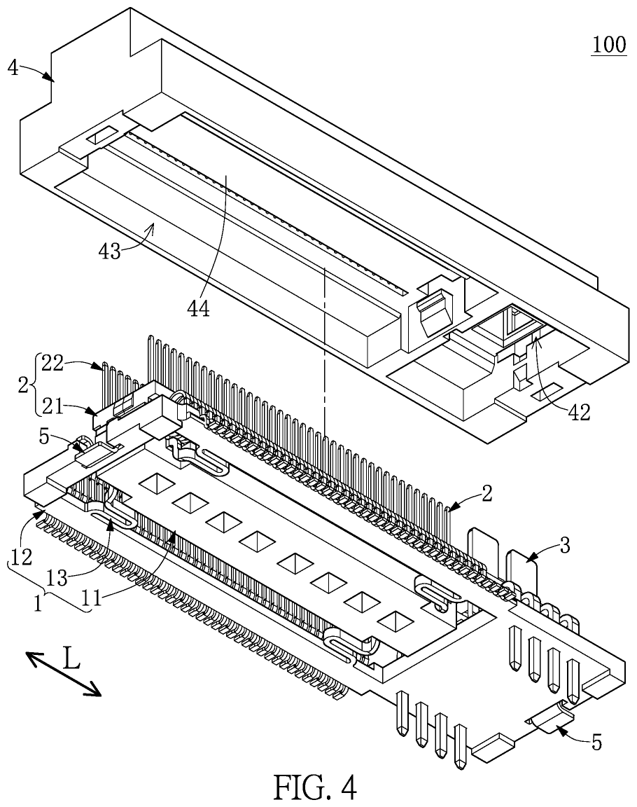

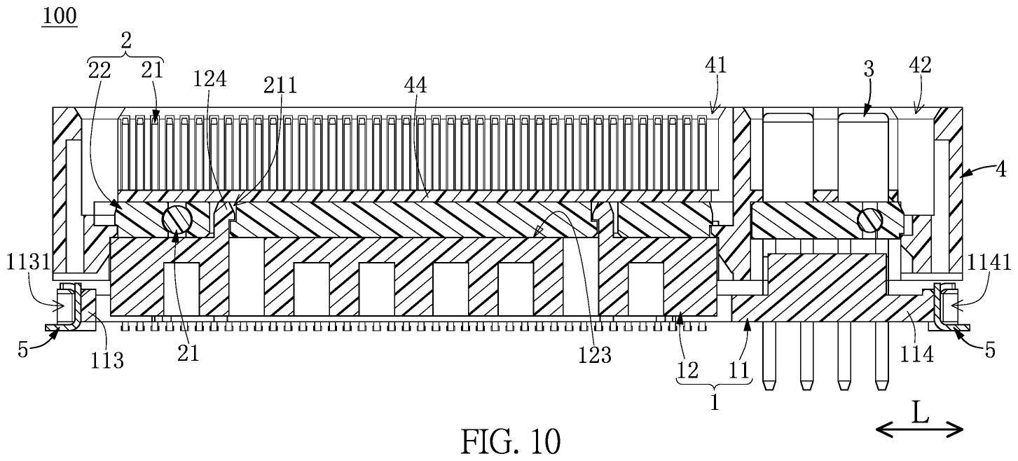

As shown in FIG. 3, FIG. 4, FIG. 9, and FIG. 10, the insertion slot 41 is recessed on a top surface of the insulating housing 4, and the insulating housing 4 has a power slot 42 recessed from the top surface thereof to a bottom surface thereof. The power slot 42 is arranged at one side of the insertion slot 41. In other words, the insertion slot 41 and the power slot 42 are arranged along the longitudinal direction L. Moreover, the insulating housing 4 has an accommodating space 43 recessed from the bottom surface thereof and corresponding in position to the insertion slot 41. The insulating housing 4 includes a partition 44 that is configured to separate the insertion slot 41 from the accommodating space 43. Moreover, the partition 44 has a plurality of terminal holes (not shown in the figures) that are respectively arranged on two opposite portions thereof and that establish spatial communication between the insertion slot 41 and the accommodating space 43.

Specifically, the insulating housing 4 is sleeved around the floating carrier 12, the partition 44 of the insulating housing 4 in the present embodiment is abutted against the top surface of the two plastic cores 21, and the two plastic cores 21 are engaged with the insulating housing 4. Moreover, the partition 44 shields the fixing holes 211 of the two plastic cores 21, and each of the two terminal modules 2 is partially arranged in the insertion slot 41 of the insulating housing 4. In addition, each of the power terminals 3 is partially arranged in the power slot 42 of the insulating housing 4.

Specifically, the two terminal modules 2 in the present embodiment are disposed in the insertion slot 41 by using the mating segments 222 of the conductive terminals 22 to respectively pass through the terminal holes of the partition 44. The S-shaped buffer segment 223 of each of the conductive terminals 22 is arranged in the insulating housing 4, and the end segment 224 of each of the conductive terminals 22 extends from the other end of the S-shaped buffer segment 223 (e.g., an end of the S-shaped buffer segment 223 away from the embedded segment 221) to pass through the insulating housing 4 for being engaged with the corresponding positioning slot 1121.

Accordingly, when the insulating housing 4 receives an external force, the insulating housing 4 is movable relative to the frame 11 along the different directions by the floating carrier 12 and the buffer arms 13, the insulating base 1 can absorb the external force through the buffer arms 13, and each of the conductive terminals 22 can absorb the external force through the S-shaped buffer segment 223, so that the floating connector 100 can have a better shockproof effect.

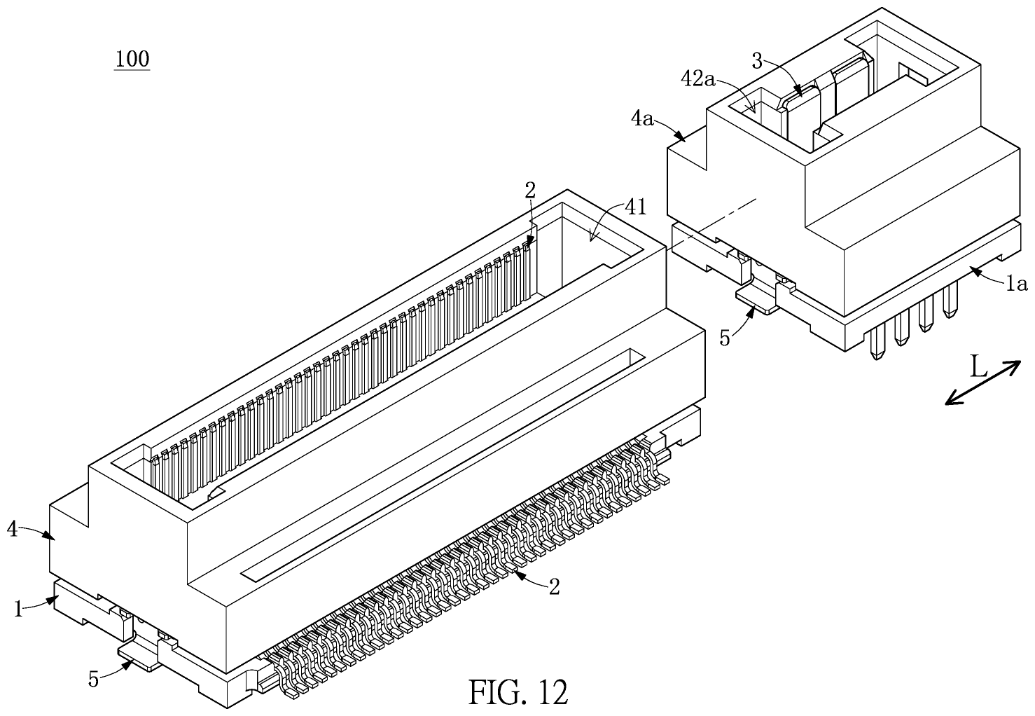

In addition, the insulating base 1 shown in FIG. 1 to FIG. 10 is integrally formed as a one-piece structure, but the present disclosure is not limited thereto. For example, as shown in FIG. 12, the floating carrier 100 can include the insulating base 1, 1a having two parts, and the insulating housing 4, 4a also having two parts that are respectively cooperated with the two parts of the insulating base 1, 1a, the insertion slot 41 and the power slot 42a being respectively formed in the two parts of the insulating housing 4, 4a. Moreover, each of the two parts of the insulating base 1, 1a is used to hold two soldering members 5, and the insulating base 1a and the insulating housing 4a are used to carry the power terminals 3. Accordingly, the power terminals 3 can be selectively provided to the floating connector 100 according to different design requirements.

In conclusion, the insulating base in the present disclosure is provided with a new structure by forming the buffer arms to connect to the frame and the floating carrier, and each of the buffer arms in the present disclosure has a new structural design, so that the insulating base can provide a buffer function by effectively absorbing the external force along the different directions, achieving a better shockproof effect of the floating connector.

Specifically, a portion of the floating carrier and a portion of the frame, which are connected to any one of the buffer arms, can be formed to satisfy a specific condition, so that the buffer arms have a better buffer function. Moreover, the terminal modules can be engaged with the floating carrier and the insulating housing through the structural design of the two plastic cores, thereby establishing a structural connection between the insulating base and the insulating housing.

In addition, when the insulating housing receives an external force, the insulating housing is movable relative to the frame along the different directions by the floating carrier and the buffer arms, the insulating base can absorb the external force through the buffer arms, and each of the conductive terminals can absorb the external force through the S-shaped buffer segment, so that the floating connector can have a better shockproof effect.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A floating connector, comprising:
an insulating base including:
a frame being in a ring-shape and including two elongated strips that are arranged on two opposite sides thereof, wherein an inner edge of the frame surroundingly defines a buffer opening;
a floating carrier spaced apart from the frame and corresponding in position to the buffer opening; and
a plurality of buffer arms connected to and arranged between the floating carrier and the frame, wherein each of the buffer arms has a first buffer segment connected to the frame and a second buffer segment that curvedly extends from the first buffer segment to the floating carrier,
wherein when the floating carrier receives an external force, the first buffer segment and the second buffer segment of any one of the buffer arms absorb the external force respectively along different directions, so that the floating carrier is moved relative to the frame along the different directions;
two terminal modules fastened to the floating carrier through one side portion thereof and respectively fastened to the two elongated strips of the frame through another side portion thereof; and
an insulating housing sleeved around the floating carrier and having an insertion slot, wherein each of the two terminal modules is partially arranged in the insertion slot of the insulating housing,
wherein the insulating housing is movable relative to the frame along the different directions by the floating carrier and the buffer arms.

2. The floating connector according to claim 1, wherein in each of the buffer arms, the first buffer segment is in a U shape and is arranged in the buffer opening, and the second buffer segment perpendicularly extends from the first buffer segment to pass through the buffer opening and to connect to the floating carrier.

3. The floating connector according to claim 1, wherein the floating carrier is in an elongated shape defining a longitudinal direction that is parallel to any one of the two elongated strips, and the buffer arms are arranged at an inner side of the two terminal modules, and wherein a portion of the floating carrier and a portion of the frame, which are connected to any one of the buffer arms, are located at a cross section of the insulating base perpendicular to the longitudinal direction.

4. The floating connector according to claim 1, wherein the floating carrier is partially arranged in the buffer opening, and the connection between the floating carrier and the frame is established only by the buffer arms.

5. The floating connector according to claim 1, wherein each of the two terminal modules includes a plastic core and a plurality of conductive terminals that are fixed to the plastic core and that are arranged in one row, and wherein the floating carrier is engaged with the plastic cores of the two terminal modules, and the plastic cores of the two terminal modules are engaged with the insulating housing.

6. The floating connector according to claim 1, wherein each of the two terminal modules includes a plastic core and a plurality of conductive terminals that are fixed to the plastic core and that are arranged in one row, and the conductive terminals of any one of the two terminal modules respectively face toward the conductive terminals of another one of the two terminal modules, and wherein each of the conductive terminals includes:
an embedded segment fixed and embedded in the corresponding plastic core;
a mating segment extending from the embedded segment and arranged in the insertion slot of the insulating housing;
an S-shaped buffer segment extending from the embedded segment and arranged in the insulating housing, wherein an end of the S-shaped buffer segment is engaged with the floating carrier; and
an end segment extending from another end of the S-shaped buffer segment to pass through the insulating housing, wherein the end segment is engaged with the frame and is configured to be soldered onto a circuit board.

7. The floating connector according to claim 1, further comprising a plurality of power terminals, wherein the insulating housing has a power slot arranged at one side of the insertion slot, any one of the power terminals is selectively fastened to the frame and is partially arranged in the power slot of the insulating housing.

8. An insulating base of a floating connector, comprising:
a frame being in a ring-shape and including two elongated strips that are arranged on two opposite sides thereof, wherein an inner edge of the frame surroundingly defines a buffer opening;
a floating carrier spaced apart from the frame and corresponding in position to the buffer opening; and
a plurality of buffer arms connected to and arranged between the floating carrier and the frame, wherein each of the buffer arms has a first buffer segment connected to the frame and a second buffer segment that curvedly extends from the first buffer segment to the floating carrier,
wherein when the floating carrier receives an external force, the first buffer segment and the second buffer segment of any one of the buffer arms absorb the external force respectively along different directions, so that the floating carrier is moved relative to the frame along the different directions.

9. The insulating base according to claim 8, wherein the floating carrier is partially arranged in the buffer opening, and wherein in each of the buffer arms, the first buffer segment is in a U shape and is arranged in the buffer opening, and the second buffer segment perpendicularly extends from the first buffer segment to pass through the buffer opening and to connect to the floating carrier.

10. The insulating base according to claim 8, wherein the floating carrier is in an elongated shape defining a longitudinal direction that is parallel to any one of the two elongated strips, and the connection between the floating carrier and the frame is established only by the buffer arms, and wherein a portion of the floating carrier and a portion of the frame, which are connected to any one of the buffer arms, are located at a cross section of the insulating base perpendicular to the longitudinal direction.
